(19) United States
(12) Patent Application Publication
(10) Pub. No.: US 2026/0277178 A1
(43) Pub. Date: Sep. 17, 2026

(54) Building Management System

(71) Applicant: NexRev Inc., Plano, TX (US)

(72) Inventors: Mighael Botha, Prosper, TX (US); Kyle Logsdon, Plano, TX (US); Kenneth Smith, Plano, TX (US)

(21) Appl. No.: 19/561,450

(22) Filed: Mar. 9, 2026

Related U.S. Application Data
(60) Provisional application No. 63/771,526, filed on Mar. 13, 2025.

(51) Int. Cl. G05B 19/042; G06K 7/14

(52) U.S. Cl. CPC G05B 19/042; G06K 7/1417; G05B 2219/25011

(57) ABSTRACT

A building management system that includes IoT-enabled devices and cloud-based platform engineered to support building automation, energy management, and operational intelligence is provided. The platform combines custom-built cellular IoT devices with real-time data analytics, AI-driven automation, and secure cloud connectivity — enabling scalable, intelligent, and adaptive control over energy consumption, asset performance, and facility operations. The building management system delivers a comprehensive, centralized platform for monitoring, managing, and optimizing IoT-connected assets, building systems, and energy infrastructures. The building management system provides intelligent, cellular-enabled edge computing device family designed specifically for building automation, thereby eliminating vendor lock-in, complex wiring, and dependency on customer IT networks.

### CROSS REFERENCE TO RELATED PATENT APPLICATIONS

The present disclosure is part of a non-provisional application that claims the priority benefit of U.S. Provisional Patent Application No. 63/771,526, filed on Mar. 13, 2025, titled “Cloud Powered Building Operations”

### BACKGROUND

### Technical Field

The present disclosure generally relates to Cloud-based management of Internet of Things (IoT).

### Description of the Related Arts

Internet of Things (IoT) refers to a network of physical objects, or “things”, that are embedded with sensors, software, and technology that connect and exchange data with other devices and systems over the Internet or the Cloud. These devices range from everyday household items like smart thermostats to industrial tools, enabling automated, real-time monitoring and data-driven decision-making.

### SUMMARY

Some embodiments of the disclosure provide a building management system that includes IoT-enabled devices and cloud-based platform engineered to support building automation, energy management, and operational intelligence. The platform combines custom-built cellular IoT devices with real-time data analytics, AI-driven automation, and secure cloud connectivity — enabling scalable, intelligent, and adaptive control over energy consumption, asset performance, and facility operations. The building management system delivers a comprehensive, centralized platform for monitoring, managing, and optimizing IoT-connected assets, building systems, and energy infrastructures. The building management system provides intelligent, cellular-enabled edge computing device family designed specifically for building automation, thereby eliminating vendor lock-in, complex wiring, and dependency on customer IT networks.

In some embodiments, the building management system includes an onboarding automation tool. The tool receives an identifier that uniquely identifies a device to be managed by a system. The tool receives a machine type selection and uses the machine type selection to fetch a machine type profile from a plurality of machine type profiles. The tool receives a setup selection and uses the setup selection to fetch setup data for the selected site based on requirement data for different sites. For example, the configuration data may be generated by using the setup data to populate a template in the fetched machine type profile. The tool generates configuration data based on the fetched setup data and the fetched machine type profile. The configuration data is then delivered to the identified device through cloud connections to onboard the machine and to control the operations of the machine.

The building management system manages multiple different devices in multiple different sites, with each device being identified by a different identifier. The identified device may be an Internet of Things (IoT) device that communicates with the building management system through cloud connection, or a machine that is communicatively coupled to the IoT. In some embodiments, the process receives the identifier by using a mobile application (running on a mobile device with a camera) to scan a QR code that uniquely identifies the IoT device.

The machine type selection may be made by the user using the mobile application and communicated to the onboarding automation tool or the building management system. The selected machine type may be a type of heating, ventilation and air conditioning (HVAC) units. Other machine types may be another type of HVAC, or HVACs of a different vendor, or a type of refrigeration units, or a type of alarms, or a type of sensors, or a type of meters, etc. The machine type profile may be derived from data provided by a vendor of machines belonging to the machine type.

The setup selection may be made by the user using the mobile application and communicated to the onboarding automation tool or the building management system. The setup selection may indicate an enterprise, a building, a part of a building, or a site of another type. The setup selection may also indicate parameters related to automation, floorplans, alarms, and/or demand response enrollment. The setup data may be specified for a building within which the device is situated or serving. The setup data may be provided by an enterprise operating the building. The setup data may include requirements for automation, floorplans, alarms, and/or demand response enrollment.

The preceding Summary is intended to serve as a brief introduction to some embodiments of the disclosure. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a Summary, Detailed Description and the Drawings are provided. Moreover, the claimed subject matter is not to be limited by the illustrative details in the Summary, Detailed Description, and the Drawings, but rather is to be defined by the appended claims, because the claimed subject matter can be embodied in other specific forms without departing from the spirit of the subject matter.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 conceptually illustrates a building management system.

FIG. 2 conceptually illustrates the configuring or onboarding of machines by the building management system.

FIGS. 3A-3C conceptually illustrate using a mobile application to perform the onboarding of the equipment to the building management system.

FIG. 4 shows using the site setup data and the machine profile to generate the configuration data for onboarding an equipment to the building management system.

FIG. 5 conceptually illustrates a process for onboarding a machine to the building management system.

FIG. 6 conceptually illustrates an example computing environment, consistent with some embodiments of the disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Some embodiments of the disclosure provide a building management system that includes IoT-enabled devices and cloud-based platform engineered to transform building automation, energy management, and operational intelligence. The platform combines custom-built cellular IoT devices with real-time data analytics, AI-driven automation, and secure cloud connectivity — enabling scalable, intelligent, and adaptive control over energy consumption, asset performance, and facility operations. As a Software-as-a-Service (SaaS) and Platform-as-a-Service (PaaS) solution, the building management system delivers a comprehensive, centralized platform for monitoring, managing, and optimizing IoT-connected assets, building systems, and energy infrastructures. The building management system provides intelligent, cellular-enabled edge computing device family designed specifically for building automation, thereby eliminating vendor lock-in, complex wiring, and dependency on customer IT networks.

Examples of IoT devices managed by the building management system include (i) compact IoT end devices such as general-purpose monitoring and control for lighting, ventilation, refrigeration monitoring, unit heaters, exhaust fans, pulse meters, and general I/O. QR code commissioning, magnetic mounting, 16-bit analog resolution, BLE mesh for wireless sensor networks (up to 8 sensors per device); (ii) advanced IoT end devices such as full HVAC RTU control (e.g., packaged DX gas/electric heat, heat pump), multi-zone lighting control, economizer control, complex multi-I/O, triac outputs for direct 24VAC switching (G, Y1, Y2, W1, W2, O reversing valve), dedicated sensor inputs (for e.g., space/supply/return temperature, humidity, CO₂), and edge computing; (iii) smart equipment such as dedicated 1-to-1 end device for protocol-enabled smart equipment, built-in vendor profiles for different vendors of HVAC, generators, metering, and VFDs. In some embodiments, the building management system performs auto configuration of these IoT end devices by using a cloud profile library.

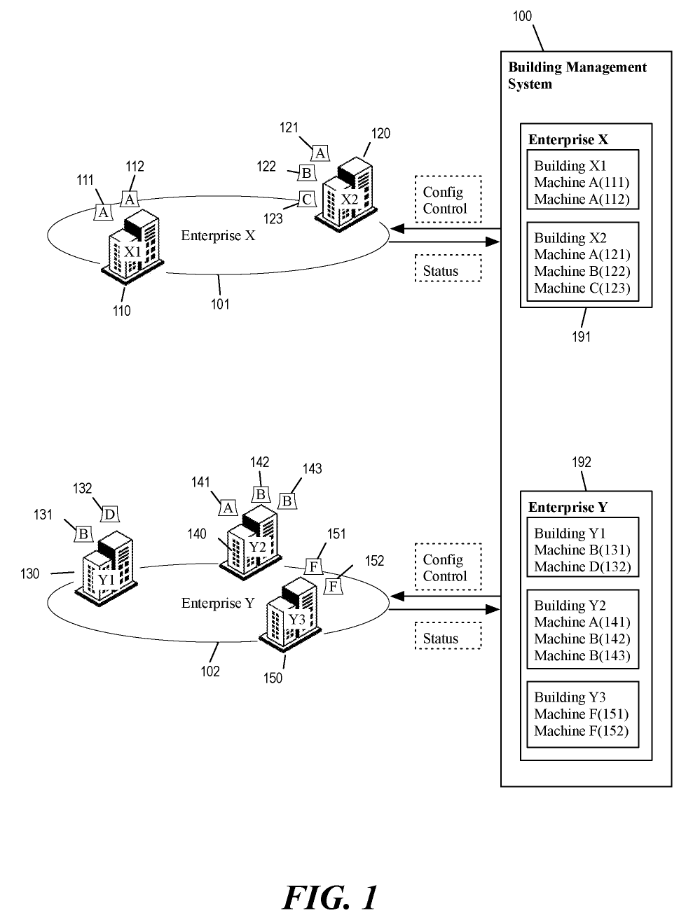

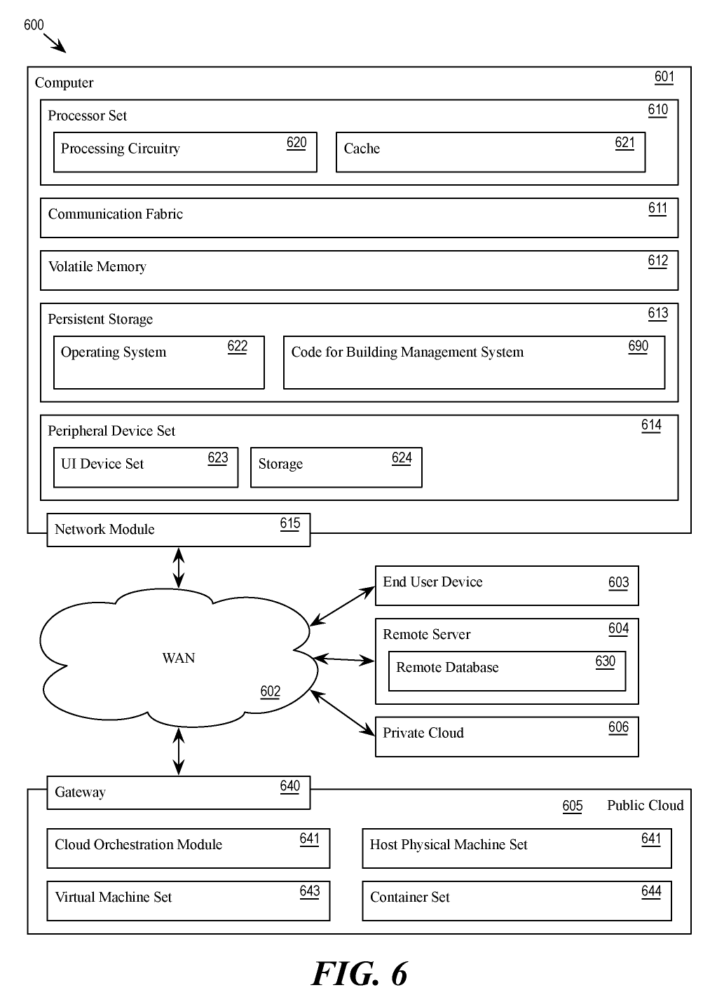

FIG. 1 conceptually illustrates a building management system 100. The building management system 100 manages the building automations of multiple enterprises, including enterprise 101 (Enterprise X) and enterprise 102 (Enterprise Y). As illustrated, Enterprise X operates two buildings X1 and X2 (buildings 110 and 120), while Enterprise Y operates three buildings Y1, Y2, and Y3 (buildings 130, 140, and 150). The building management system 100 may keep corresponding data structures for each machine being managed. The building management system 100 may be implemented by one or more computing devices connected to the cloud in some embodiments. An example of such a cloud connected computing environment will be described by reference to FIG. 6.

The machines of these buildings are configured and managed by the building management system 100, as these machines are either IoT devices or devices that are connected (or communicatively coupled) to IoT devices that can communicate with the system 100. In the example, the building 110 has machines 111 and 112 being managed, the building 120 has machines 121, 122, and 123 being managed, the building 130 has machines 131 and 131 being managed, the building 140 has machines 141, 142, and 143 being managed, and the building 150 has machines 151 and 152 being managed.

The building management system 100 may send configuration and control data through the Internet or cloud connectivity to the machines being managed. The machines may send status back to the building management system 100 through the Internet or cloud connectivity as well. Each machine is uniquely identified and managed by the building management system 100. Each machine is configured based on the profile of its machine type and the profile of its site/location/building/enterprise. Thus, two machines of an identical type may be configured differently according to the requirement of the building and/or of the enterprise it belongs to. For example, machines 111, 112, 121, 141, though are all “machine A”, may each be configured differently under the building management system 100 according to the requirements of enterprise X, enterprise Y, as well as that of buildings 110, 120, and 140.

In some embodiments, the building management system 100 includes a multi-Layer firmware and software architecture that incorporates a multi-layer firmware and software stack enabling real-time OTA updates and upgrades without system downtime. This ensures continuous operation and seamless deployment of performance enhancements and security patches. In some embodiments, the building management system may also provide advanced bi-directional connectivity by supporting bi-directional communication using various protocols for robust data exchange and remote command execution.

The building management system 100 performs adaptive protocol configuration by using an intelligent profile layer to dynamically configure communication protocols and register settings based on connected equipment specifications. A library of machine/device profiles is implemented for automated setup of equipment from different vendors. In some embodiments, this is accomplished by an onboarding automation tool.

The building management system 100 allows resilient multi-carrier cellular communication. The system is engineered for near-zero downtime with intelligent carrier selection algorithms that dynamically switch between available LTE Cat M1/NB-IoT carriers to maintain continuous connectivity.

In some embodiments, the building management system 100 provides edge computing and autonomous operations. A processor with edge-based intelligence enables autonomous device management at each machine. Distributed architecture ensures no single point of failure, such that critical systems maintain optimal performance even during cloud connectivity interruptions.

In some embodiments, the building management system 100 provides an enhanced cybersecurity framework. The system uses certificate-based authentication, cryptographic key management with automated key cycling, tamper-resistant security model, and zero-trust architecture (ZTA). Encrypted LTE cellular connectivity isolates devices from customer IT networks.

### A. Cloud Platform

In some embodiments, the building management system 100 provides a cloud platform with multi-tenant cloud architecture and security framework. The framework is a true multi-tenant architecture with compute resource pooling, logical data isolation, and workload distribution across clients. The system provides secure, tenant-specific data segregation, including by data segmentation and processing isolation, to ensure compliance with high-security environments and industry regulations. The system supports dynamic scalability by e.g., including cloud-native elastic compute resources scale to millions of devices with consistent costs and predictable OPEX. The system has an open API Ecosystem, in which APIs such as REST, GraphQL, and WebSocket facilitate secure partner/client integrations and third-party application extensibility. The system provide custom branding and role-based Access, including partner and client-specific rebranding with granular RBAC for multi-organizational deployment.

The building management system 100 provides an IoT device management and control platform for the cloud. The system as such a platform provides multi-layer device lifecycle management, including device provisioning, modification, visualization, and deactivation with secure authentication and access control. The system provides standardized data modeling that maps IoT device metadata to a common data model for seamless integration across heterogeneous IoT ecosystems. The system provides bi-directional IoT control framework with Real-time telemetry ingestion, command execution, and firmware over-the-air (FOTA) updates for remote device management.

The building management system 100 as a cloud platform also performs data intelligence, For IoT data ingestion, processing, and real-time intelligence, the system provides high-throughput data pipeline for ingesting IoT telemetry using MQTT, AMQP, and RESTful protocols, ensuring low-latency event processing across millions of connected devices. The system has edge-aware storage and forwarding that stores and forwards time-series data to cloud infrastructure with optimized data retention policies and edge-side buffering. The system provides event-driven automation with real-time event triggering, anomaly detection, and AI-driven automated responses for operational efficiency.

The building management system 100 as a platform also provides AI-driven insights, dashboarding, and autonomous operations. The system provides intelligent dashboarding and visualization, such as enterprise map views with weather overlays, 2D/3D interactive floorplans, real-time device status, and agentic AI assistants for queries and commands. A multi-agent AI specialist architecture with domain-specific specialist agents (HVAC, Power, Energy, FDA/Refrigeration, Sensors, Alarms, Building Control, Site Analysis) coordinate to deliver expert-level insights. The system has edge-aware AI processing, localized AI models performing inference on edge devices while synchronizing aggregated insights to the cloud for continuous optimization. The system provides PaaS for energy and building management applications. Modular PaaS is provided by the system for vertical solutions for application development and deployment framework for industry-specific energy and facility management solutions. The system also has real-time event handling and decision engines that facilitates event-driven computing executes rules, workflows, and automation tasks based on IoT events. In some embodiments, an application development framework is provided for the cloud platform of the building management system with API-driven extensibility, microservices-based deployment, and multi-instance tenant isolation. Core application and third-party partner integrations via REST, GraphQL, and WebSocket APIs with MCP (Model Context Protocol) may be used for AI-to-AI interoperability. Containerized, serverless, and edge-compatible microservices may be used to optimize platform scalability. Each application instance operates within a logically isolated environment, ensuring regulatory and security compliance.

In some embodiments, the building management system 100 provides application PaaS. The PaaS provides client, channel, and user management, with multi-tenant user management with role-based authentication and fine-grained access control. The PaaS provides AI-powered analytics and reporting, with intelligent energy consumption analytics, demand forecasting, EUI tracking, and operational insights. The PaaS provides demand response and load management, with automated load adjustments based on real-time energy demand fluctuations, integrated with automated demand response (ADR) programs. The PaaS provides HVAC Optimization & Load Balancing, with AI-driven HVAC runtime optimization with Delta-T analysis, integration for significant energy savings. The PaaS provides role-based AI agents and chatbots accessible on desktop and mobile for real-time reports, scheduled updates, and ad-hoc commands. The PaaS provides extensible partner application marketplace, with open plugin framework supporting custom partner applications for third-party software integrations.

### B. Mobile Application

In some embodiments, the building management system 100 allows access and control by the user through a mobile application (running on a mobile device such as a smartphone or a computing device of another type), particularly with regards to following aspects of IoT commissioning and management:
(1) AI-driven commissioning and configuration of the IoT devices, which integrates an AI-powered wizard for automated machine and building commissioning without specialized expertise. In some embodiments, each IoT device is assigned a unique identifier such as a QR code, such that the unique identifier can be used to initiate instant device onboarding (e.g., by QR code scanning). For example, a user may scan the QR code, select equipment type, choose configuration profile, and then let the building management system handles the onboarding of the IoT device from behind the cloud.
(2) Cloud-integrated intelligent device identification, which leverages cloud-based APIs and machine learning for real-time machine discovery, automated connection configuration, and seamless deployment of IoT device communication settings. Device-specific parameters are dynamically retrieved and transmitted from a machine profile library.
(3) Real-time monitoring building and machine monitoring, available through interactive analytics interface that provides real-time diagnostics, anomaly detection, and predictive issue resolution tools. Temporary setpoint adjustments (1hr, 12hr, 24hr, custom), lighting overrides, and sensor trend graphs may be available from any mobile device.
(4) Scalable portfolio management, which is designed for enterprise-scale environments, by monitoring, managing, and controlling thousands of IoT-enabled buildings and machines from a centralized mobile interface. Batch processing may be launched for system-wide updates, device grouping, and automated alerts for operational irregularities; and
(5) Granular access control and security, which includes multi-layered authentication and role-based access control (RBAC) to enforce granular permissions at the building, site, and individual machine level. Dynamic provisioning, revocation, and restriction of access may be performed based on real-time operational requirements.

### C. Onboarding Automation Tool

As mentioned, in some embodiments, the building management system 100 performs adaptive protocol configuration by using an intelligent profile layer to dynamically configure communication protocols and register settings based on connected equipment specifications. In some embodiments, to configure or onboard a machine in a building for a customer enterprise, the configuration data for the machine is generated according to (i) a library of machine/device profiles that is implemented for automated setup of equipment from different vendors, and (ii) an enterprise setup specific to the enterprise to specify corporate operating standards, building configurations, and automation policies.

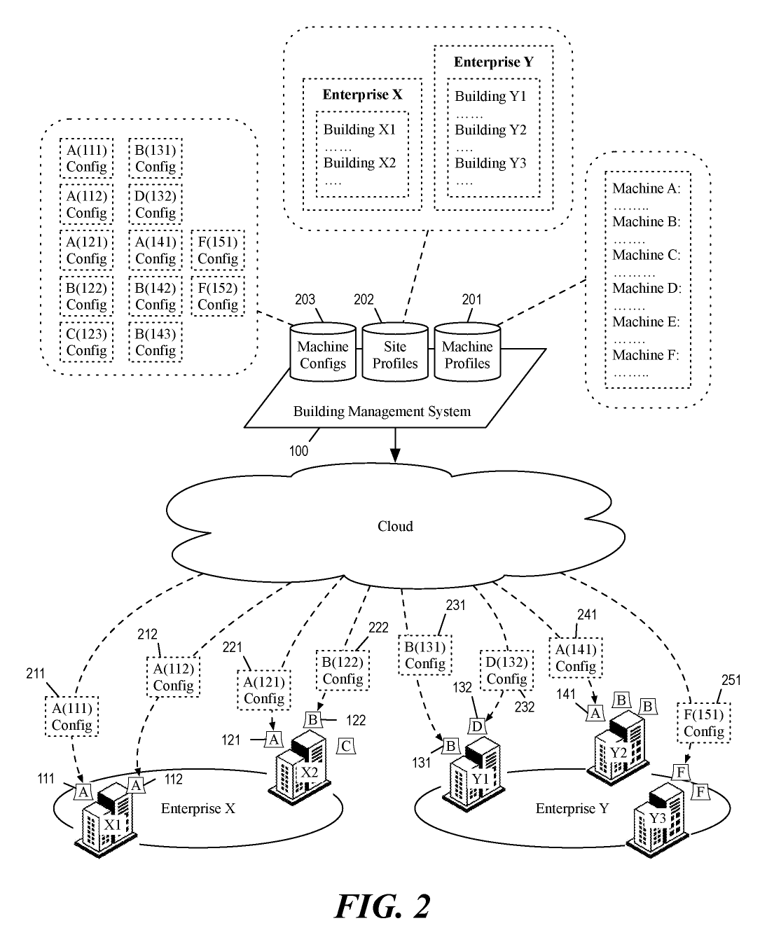

FIG. 2 conceptually illustrates the configuring or onboarding of machines by the building management system. As illustrated, the building management system 100 generates and/or stores data for machine profiles library 201, site profiles (or enterprise setup) library 202, and machine configurations 203.

The machine profiles library 201 includes profiles for different types of machines, which may come from different vendors. The profile of a machine type specifies data specific to that machine type, though not necessarily of an individual machine. In the example, each machine type A, B, C, D, E, F, has its own profile. In some embodiments, a machine profile may include templates to be filled with data specific to an enterprise and/or building site when a machine of that machine type is actually onboarded for the building management system.

The site profiles library 202 includes setup data specific to a customer enterprise and/or building. Such setup data may specify corporate operating standards, building configurations, automation policies, and other setup requirements for the site. In some embodiments, a site profile for a building may be generated by using automation frameworks for floorplans, alarms, demand response enrollment, etc.

The machine configurations 203 stores configuration data that are generated specifically for individual machines. As illustrated, configuration data for machines in buildings X1, X2, Y1, Y2, and Y3 are generated and delivered to those machines. The configuration data of a machine may be in a format that is understood by the machine and specific to the machine, as specified by the vendor of the machine. The configuration data for a machine in a building may be generated based on a machine profile from the machine profiles 201 and setup data for the building from the site profiles 202. In some embodiments, the configuration data for each machine includes data that are used to configure the machine and data that are used by the building management system 100 to control the machine. In some embodiments, the configuration data for each machine is associated with a unique identifier of an IoT that is connected to machine.

In the example, separate configuration data 221 and 222 are generated and delivered to machines 121 and 122 respectively. The machine 121 is a “machine A” and its configuration data 221 is generated based on profile for machine A, and the machine 122 is a “machine B” and its configuration data 222 is generated based on profile for machine B. Since both machines 121 and 122 are installed for building X2, their configuration data 221 and 222 are generated based on site profile of building X2.

Also in the example, separate and different configuration data 211, 212, 221, 241 are generated and delivered to the machines 111, 112, 121, and 141, respectively, even though machines 111, 112, 121, and 141 are all “machine A”. Specifically, the configuration data 211 for the machine 111 is generated based on the site profile of building X1 and Enterprise X, while the configuration data 241 for machine 141 is generated based on the site profile of building Y2 of Enterprise Y.

Also in the example, even though the machines 111 and 112 are both “machine A” in building X1 of Enterprise X, the site profile of building X1 may have different requirement regarding automation, floorplans, alarms, and/or demand response enrollment for these two machines. For example, the machine 111 may be required to serve a first part of building X1 with a first floorplan while the machine 112 may be required to serve a second, different part of building X1 with a second, different floorplan.

In some embodiments, an onboarding automation tool (or onboarding automation wizard, or “Enterprise Assistant”) is provided to assist users / customers when onboarding machines to be managed by the building management system 100. The use of the onboarding automation tool streamlines the onboarding, configuration, and operational management of large-scale equipment andbuilding fleets. The tool captures information about a building portfolio in a user-friendly manner. For each piece of equipment in a building, the captured information is used in conjunction with a machine profile, to automatically generate a specific set of rules or settings for the piece of equipment operating in the building. For example, A user may onboard a HVAC unit in building X1 of Enterprise X by reporting that a new HVAC of a particular make is to be commissioned in building X1. The onboarding automation tool would in turn generate settings for the new HVAC to operate in building X1 according to Enterprise X’s requirements and HVAC’s machine profile (e.g., “set to 72º from 9:00AM to 9:00PM”). Likewise, another user may onboard a HVAC unit in building Y2 of Enterprise Y by reporting that a new HVAC is to be commissioned in building Y2. The onboarding automation tool would in turn generate settings for the new HVAC to operate in building Y2 according to Enterprise Y’s requirements and the HVAC’s machine profile (e.g., “set to 70º from 8:30AM to 6:00PM”). Even if the new HVACs being onboarded in the two different buildings are identical, the settings or operating rules may still be different according to each enterprise’s own settings.

For some embodiments, the onboarding automation tool is an AI-powered, interactive commissioning system. The wizard utilizes machine learning models trained on historical building performance data, energy consumption patterns, and environmental conditions to recommend optimized control parameters for HVAC, lighting, and energy systems. In some embodiments, the onboarding automation tool integrates a Q&A-driven guidance system with embedded AI agents, enabling users to dynamically configure building automation settings without requiring specialized expertise. The automation settings may be continuously refined through feedback loops, ensuring evolving optimization based on real-world performance metrics.

The onboarding automation tool may integrate knowledge from multiple sources by ingesting and synthesizing data from authoritative sources such as ASHRAE (American Society of Heating, Refrigerating, and Air-Conditioning Engineers), weather forecasting APIs, and energy standards databases. The process may use contextual AI reasoning to derive the most efficient operational settings for different building types, climates, and energy policies. The onboarding automation tool may enable scalable fleet-wide automation and deployment, by supporting multi-site building automation by applying standardized control models across thousands of buildings, ensuring consistency and compliance with regulatory guidelines. The onboarding automation tool implements automated commissioning workflows, dynamic system tuning, and real-time performance validation to scale automation efforts across diverse property portfolios. The onboarding automation tool may incorporate self-learning algorithms that enhance predictive maintenance, HVAC optimization, and demand-response strategies to drive energy efficiency and operational resilience. The onboarding automation tool may include embedded AI Agents for operational efficiency. The AI agents actively monitor system performance, detect inefficiencies, and propose automated corrective actions based on real-time telemetry and historical trends.

As mentioned, the onboarding automation tool is an AI and Q&A driven configuration wizard for enterprise-scale building automation. The onboarding automation tool provides a guided, step-by-step interface that enables users or facilities teams to configure, automate, and manage an entire building portfolio from a single cloud interface without requiring specialized building automation expertise. Rather than relying on scarce controls engineers for every configuration task, the onboarding automation tool captures enterprise operating standards, automation policies, and equipment profiles in reusable frameworks that are automatically applied whenever a new machine is commissioned.

The onboarding automation tool can also be used to define enterprise-wide and site-specific automation frameworks, such as HVAC setpoints, heating/cooling schedules, occupancy rules, operating parameters, and energy policies. The onboarding automation tool also configures templates that enforce corporate standards while allowing regional or site-level customization.

In some embodiments, the onboarding automation tool provides several (enterprise assistant) automation frameworks, including an automation assistant, a floorplan assistant, an alarm assistant, and an automated demand response (ADR) assistant. The floorplan assistant uploads and configures interactive building floor plans with pre-defined control areas (sales floor, warehouse, reception, loading dock). The floorplan assistant maps equipment types and zones to physical spaces, creating a visual representation of each building’s automation layout. The alarm assistant configures alarm thresholds, severity levels, escalation rules, and notification workflows for every equipment type and zone across the portfolio. The ADR assistant manages ADR program participation and defines how each location and/or control area responds to demand response events with fine-grained control over load curtailment strategies per zone.

In some embodiments, equipment operations under the building management system are defined by two independent and parallel processes that can be completed in any order or simultaneously. The two independent processes (Track A and Track B) run in parallel and converge for the commissioning of equipment under the building management system. Track A is used for machine profile creation while Track B is used for enterprise (customer-defined) setup. The onboarding automation tool combines customer-defined automation frameworks generated by Track B with machine profiles created by Track A to deliver a complete intelligence package to each IoT device at the moment of field commissioning. In some embodiments, an AI powered packaging process is used to merge the output of the Track A and the output of Track B into one command package (or machine configuration data) for the onboarding.

Track A is used for machine profile creation by e.g., defining controllers, mapping makes and models, and programming sequence of operations. Track A defines how each type of connected machine is controlled and operated. This process creates reusable machine profiles that capture the complete operational definition for every equipment type across the enterprise. Track A creates or selects the controller definition for each machine type: HVAC controller, lighting controller, generator controller, refrigeration controller, etc. Each controller type defines the fundamental control architecture and capabilities for its equipment category. Track A also maps specific machine manufacturers and models to the appropriate controller. For example: Lennox™, Trane™, and Carrier™ units are mapped to a HVAC machine controller, while Generac™, Cummins™, and Kohler™ are mapped to a generator controller. Track A defines the complete sequence of operations and control programming for each controller, including startup/shutdown procedures, stage control, safety interlocks, economizer logic, demand limiting, and operational parameters. This programming governs how the machine is operated, monitored, and protected.

Track B is used for enterprise setup, for e.g., automation, floorplans, alarms, demand response enrollment. Track B captures the customer’s corporate operating standards, building configurations, and automation policies (through the guided modules in the onboarding automation tool in some embodiments). These settings can be applied globally across the enterprise or customized per region, state, city, or individual site. For the automation framework, Track B defines corporate-wide HVAC and lighting standards, heating/cooling setpoints, operating schedules, occupancy rules, energy policies; to be applied globally or customized per region/state/city/site. For floorplan configuration, Track B uploads building floor plans, defines control zones and areas (HVAC zones, lighting zones, refrigeration areas), maps equipment to physical spaces. For alarm configuration, Track B sets alarm thresholds, severity levels, and escalation rules for all monitored points across the portfolio. For ADR enrollment, Track B may configure ADR participation with partners, and define per-location and per-zone event handling and load curtailment strategies.

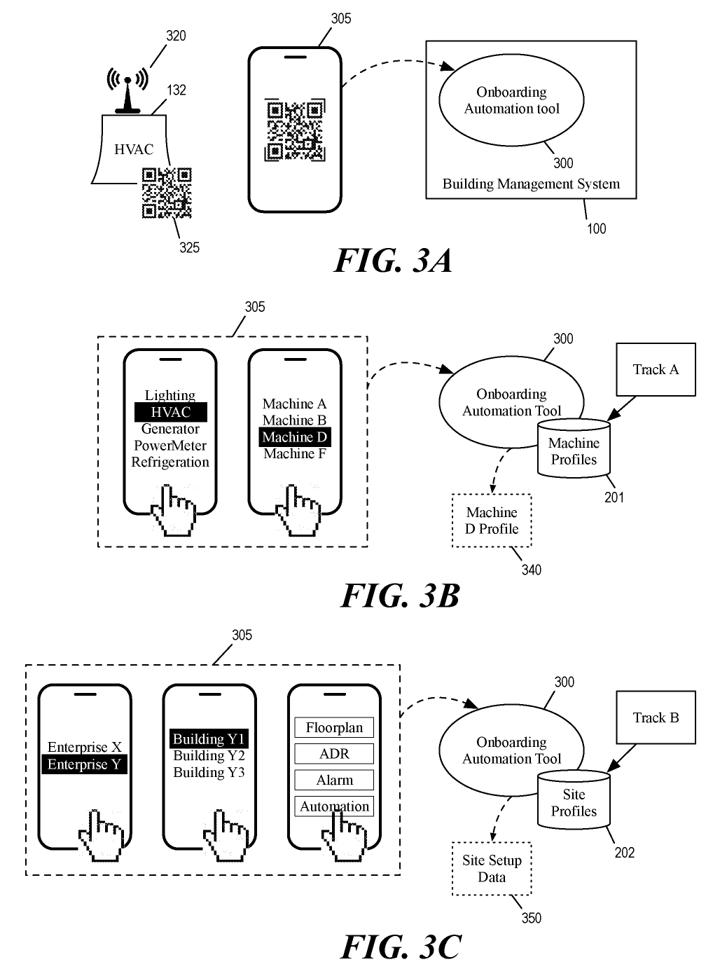

In some embodiments, to onboard a piece of equipment in a building or a site of an enterprise, the use may use the mobile application to provide a few information to the onboarding automation tool. The equipment being onboarded may be HVAC, RTU, lighting panel, generator, etc. The onboarding automation in turn uses the information to automate the configuration / onboarding of the equipment to the building management system. FIGS. 3A-3C conceptually illustrate using a mobile application 305 to perform the onboarding of the equipment 132 (which is a “machine D” as shown in FIGS. 1 and 2) to the building management system 100. The onboarding operations are automated by the onboarding automation tool 300 of the building management system 100. The mobile application 305 is described further in Section B above.

FIG. 3A shows the user providing a unique identifier (e.g., by scanning a QR code / bar code, entering a serial number, etc.) to report or register the piece of equipment 132 to the building management system. In example illustrated, a user may magnetically mount an IoT 320 to the piece of equipment 132, connect power, and scan a unique QR code 325 of the IoT 320 using the mobile app 305. The QR code is used to uniquely identify the IoT and the associated (mounted/ connected/ communicatively coupled) piece of equipment to the building management system 100.

FIG. 3B shows the user selecting a machine type of the equipment, e.g., by choosing an equipment category (e.g., HVAC, lighting, generator, power meter, refrigeration) and select a specific machine type via the mobile application 305. In the example, the user selects “HVAC”, which then brings up possible machine types A, B, D, and F, from which the user selects “Machine D”. The selection is used by the onboarding automation tool 300 to select a machine profile 340 from the library of machine profiles 201 for “Machine D”. The machine profile 340 may include make/model-specific control logic and programming for the specific type/make of the machine. The content of the machine profiles library 201 is generated by the Track A process described above for some embodiments.

FIG. 3C shows the user selects a customer location to identify the customer site that hosts the IoT, using the mobile application 305. In the example, the selection specifies for which enterprise/organization and for which building is the machine to be onboarded. The mobile application 305 also provide access to various (enterprise assistant) automation frameworks of the onboarding automation tool 300, which automates the setting of setpoints, floorplans, schedules, alarms, ADR rules, zone configurations, etc., according to user selections within the automation frameworks. In some embodiments, the mobile application uses a Q&A-driven guidance interface with embedded AI agents to capture the user selections. The onboarding automation tool 300 uses the user selections to lookup relevant information from the site profiles library 202 to generate a site setup data 350. The content of the site profiles library 202 is generated by the Track B process described above for some embodiments.

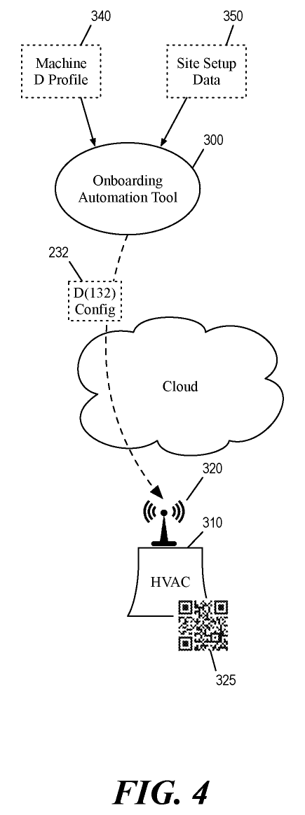

FIG. 4 shows the onboarding automation tool 300 using the site setup data 350 and the machine profile 340 to generate the configuration data 232 for onboarding the equipment 132 to the building management system 100. In some embodiments, to generate the configuration data 232, the onboarding automation tool 300 by packaging the site setup data 350 according to templates specified by the machine profile 340 or by populating such templates with relevant information from the site setup data 350. With the configuration data 232 and the unique identifier 325, the building management system 100 can identify and control the equipment 132 at the IoT 320 through the cloud connection. Thus, the complete chain from enterprise policy to device-level autonomous operation is completely automated.

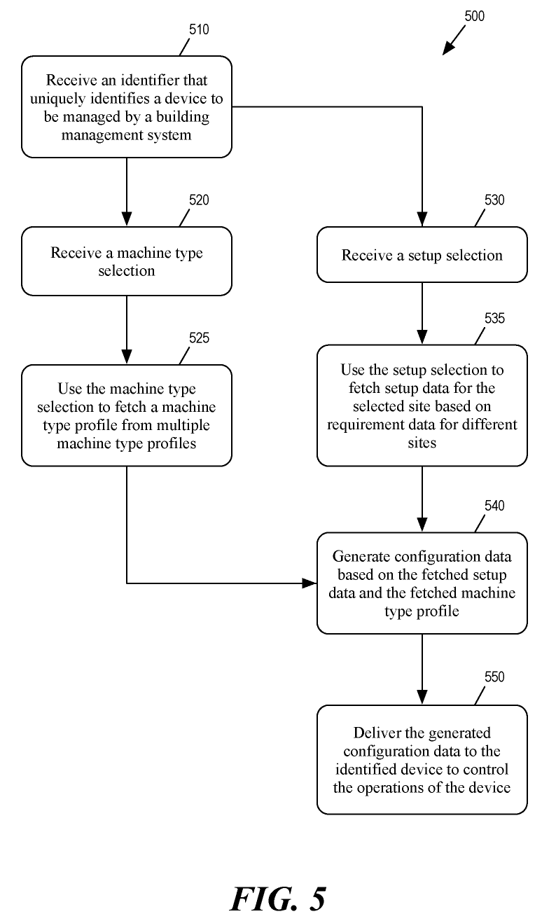

FIG. 5 conceptually illustrates a process 500 for onboarding a machine to the building management system. In some embodiments, one or more processing units (e.g., processor) of a computing device implementing the building management system 100 or the onboarding automation tool 300 performs the process 500 by executing instructions stored in a computer readable medium.

The process receives (at block 510) an identifier that uniquely identifies a device to be managed by the building management system. The system manages multiple different devices in multiple different sites, with each device being identified by a different identifier. The identified device may be an Internet of Things (IoT) device that communicates with the building management system through cloud connection, or a machine that is communicatively coupled to the IoT. In some embodiments, the process receives the identifier by using a mobile application (running on a mobile device with a camera) to scan a QR code that uniquely identifies the IoT device, as described above by reference to FIG. 3A above.

The process receives (at block 520) a machine type selection. The machine type selection may be made by the user using the mobile application and communicated to the onboarding automation tool 300 or the building management system performing this process, as described by reference to FIG. 3B above. The selected machine type may be a type of heating, ventilation and air conditioning (HVAC) units. Other machine types may be another type of HVAC, or HVACs of a different vendor, or a type of refrigeration units, or a type of alarms, or a type of sensors, or a type of meters, etc.

The process uses (at block 525) the machine type selection to fetch a machine type profile from a plurality of machine type profiles (generated by “Track A”). The machine type profile may be derived from data provided by a vendor of machines belonging to the machine type.

The process receives (at block 530) a setup selection. The setup selection may be made by the user using the mobile application and communicated to the onboarding automation tool 300 or the building management system performing this process, as described by reference to FIG. 3C above. The setup selection may indicate an enterprise, a building, a part of a building, or a site of another type. The setup selection may also indicate parameters related to automation, floorplans, alarms, and/or demand response enrollment.

The process uses (at block 535) the setup selection to fetch setup data for the selected site based on requirement data for different sites/ buildings/ enterprises (generated by “Track B”). The setup data may be specified for a building within which the device is situated or serving. The setup data may be provided by an enterprise operating the building. The setup data may include requirements for automation, floorplans, alarms, and/or demand response enrollment.

The process generates (at block 540) configuration data based on the fetched setup data for the selected site and the fetched machine type profile. For example, the configuration data may be generated by using the setup data to populate a template in the fetched machine type profile. The process delivers (at block 550) the generated configuration data to the identified device, and the configuration data is used to control the operations of the machine and to onboard the machine to the building management system. The configuration data may be in a format that is specific to machines of the machine type selection.

The flowchart in FIG. 5 illustrates the operation of possible implementations of systems, methods, or computer program products according to various embodiments of the present disclosure. In this regard, each block in the flowchart may represent a module, segment, or portion of instructions for implementing the specified operation(s). In some alternative implementations, the operations noted in the blocks may occur out of the order noted in the FIG. 5. For example, two blocks shown in succession may, in fact, be executed substantially concurrently, or the blocks may sometimes be executed in the reverse order, depending upon the operations involved.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 conceptually illustrates an example computing environment 600, consistent with some embodiments of the disclosure. The computing environment 600 contains an example of an environment for the execution of at least some of the computer code involved in performing the inventive methods, such as the building management system 100 and the onboarding automation tool 300.

The computing environment 600 may include, for example, computer (or computing device) 601, wide area network (WAN) 602, end user device (EUD) 603, remote server 604, public cloud 605, and private cloud 606. In the embodiment illustrated, the computer 601 includes processor set 610 (including processing circuitry 620 and cache 621), communication fabric 611, volatile memory 612, persistent storage 613 (including operating system 622 and a block 690 for storing data/instructions of the building management system, as described above), peripheral device set 614 (including user interface (UI) device set 623, storage 624), and network module 615. Remote server 604 includes remote database 630. Public cloud 605 includes gateway 640, cloud orchestration module 641, host physical machine set 642, virtual machine set 643, and container set 644.

The computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. The computer 601 may be located in a cloud, even though it is not shown in a cloud in FIG. 6. On the other hand, computer 601 is not required to be in a cloud except to any extent as may be affirmatively indicated.

The processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in the block 690 in persistent storage 613.

The communication fabric 611 is the signal conduction path that allows the various components of computer 601 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

The volatile memory 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

The persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in the block 690 typically includes at least some of the computer code involved in performing the inventive methods, namely for the building management system described above.

The peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

The network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

The WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

The remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

The public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving an identifier that uniquely identifies a device to be managed by a system;
receiving a machine type selection;
receiving a setup selection;
using the machine type selection to fetch a machine type profile from a plurality of machine type profiles;
using the setup selection to fetch setup data for the selected site based on requirement data for different sites;
generating configuration data based on the fetched setup data and the fetched machine type profile; and
delivering the generated configuration data to the identified device.

2. The method of claim 1, wherein the identified device is an Internet of Things (IoT) device.

3. The method of claim 2, wherein the IoT device is communicatively coupled to a machine of the selected machine type.

4. The method of claim 3, wherein the configuration data is used to onboard the machine of the selected machine type to the system.

5. The method of claim 1, wherein receiving the identifier comprises using a mobile application to scan a QR code.

6. The method of claim 1, wherein the setup selection indicates parameters related to automation, floorplans, alarms, or demand response enrollment and the setup data comprises requirements for at least one of automation, floorplans, alarms, and demand response enrollment.

7. The method of claim 1, wherein the system manages a plurality of devices in a plurality of different sites, each device being identified by a different identifier.

8. The method of claim 1, wherein the setup data is specified for a building within which the device is situated.

9. The method of claim 1, wherein the configuration data is generated by using the setup data to populate a template in the fetched machine type profile.

10. The method of claim 1, wherein the machine type profile is derived from data provided by a vendor of machines belonging to the machine type.

11. The method of claim 1, wherein the selected machine type is a type of heating, ventilation and air conditioning (HVAC) units.

12. The method of claim 1, wherein the configuration data is in a format that is specific to machines of the machine type selection.
